(19) United States
(12) Patent Application Publication
(10) Pub. No.: US 2010/0166076 A1
(43) Pub. Date: Jul. 1, 2010

(54) METHOD, APPARATUS, AND COMPUTER READABLE MEDIUM FOR CALCULATING RUN AND LEVEL REPRESENTATIONS OF QUANTIZED TRANSFORM COEFFICIENTS REPRESENTING PIXEL VALUES INCLUDED IN A BLOCK OF A VIDEO PICTURE

(75) Inventor: Lars Petter ENDRESEN, Nesoddtangen (NO)

Correspondence Address: OBLON, SPIVAK, MCCLELLAND MAIER & NEUSTADT, L.L.P., 1940 DUKE STREET, ALEXANDRIA, VA, 22314, US

(73) Assignee: Tandberg Telecom AS, Lysaker (NO)

(21) Appl. No.: 12/649,764

(22) Filed: Dec. 30, 2009

Related U.S. Application Data
(60) Provisional application No. 61/142,648, filed on Jan. 6, 2009.

(30) Foreign Application Priority Data
Dec. 30, 2008 (NO) 20085407

(51) Int. Cl. H04N 7/30

(52) U.S. Cl. 375/240.18; 375/E07.226

(57) ABSTRACT

A process for calculating run-and-level representations of quantized transform coefficients includes packing each quantized transform coefficients in a value interval [Max, Min] by setting all quantized transform coefficients greater than Max equal to Max, and all quantized transform coefficients less than Min equal to Min; reordering the quantized transform coefficients resulting in an array C of reordered quantized transform coefficients; masking C by generating an array M containing ones in positions corresponding to positions of C having non-zero values, and zeros in positions corresponding to positions of C having zero values; and for each position containing a one in M, generating a run and a level representation by setting the level value equal to an occurring value in a corresponding position of C, and setting the run value equal to the number of proceeding positions relative to a current position in M since a previous occurrence of one in M.

### CROSS-REFERENCE TO RELATED APPLICATIONS

The present application claims the benefit under 35 U.S.C. §119 of U.S. Provisional Application No. 61/142,648, filed Jan. 6, 2009, and priority from Norwegian Patent Application No. 20085407, filed Dec. 30, 2008, the entire subject matter of both of which are incorporated herein by reference.

### BACKGROUND

1. Field of the Invention

The present disclosure relates to an implementation of entropy coding/decoding of transform coefficient data of video compression systems in computer devices or systems.

2. Description of the Related Art

Transmission of moving pictures in real time is employed in several applications such as, but not limited to, video conferencing, net meetings, television (TV) broadcasting, and video telephony. Representing moving pictures requires bulk information as digital video typically is described by representing each pixel in a picture with 8 bits, which is equal to 1 byte. Such uncompressed video data results in large bit volumes, and cannot be transferred over conventional communication networks and transmission lines in real time due to limited bandwidth.

Thus, enabling real time video transmission requires a large extent of data compression. Data compression may, however, compromise the picture quality. Therefore, great efforts have been made to develop compression techniques allowing real time transmission of high quality video over bandwidth limited data connections. In video compression systems, the main goal is to represent the video information with as little capacity as possible. Capacity is defined with bits, either as a constant value or as bits/time unit. In both cases, the goal is to reduce the number of bits.

A conventional video coding method is described in the Moving Picture Experts Group (MPEG) and H.26 standards. The video data undergoes four main processes before transmission (i.e., the prediction process, the transformation process, the quantization process, and the entropy coding).

The prediction process reduces the amount of bits required for each picture in a video sequence to be transferred. The process takes advantage of the similarity of parts of the sequence with other parts of the sequence. Since the predictor part is known to both encoder and decoder, only the difference has to be transferred. This difference typically requires much less capacity for its representation. The prediction is mainly based on vectors representing movements. The prediction process is conventionally performed on square block sizes (e.g., 16×16 pixels). Note that in some cases, predictions of pixels based on adjacent pixels in the same picture, rather than pixels of preceding pictures, are used. This is referred to as intra prediction (not to be confused with inter prediction).

The residual represented as a block of data (e.g., 4×4 pixels) still contains internal correlation. A conventional method which takes advantage of this and performs a two-dimensional block transform. In H.263, an 8×8 Discrete Cosine Transform (DCT) is used, whereas in H.264, a 4×4 integer-type transform is used. This transforms 4×4 pixels into 4×4 transform coefficients which can usually be represented by fewer bits than the pixel representation. Transform of a 4×4 array of pixels with internal correlation may result in a 4×4 block of transform coefficients with much fewer non-zero values than the original 4×4 pixel block.

Direct representation of the transform coefficients is too costly for many applications. A quantization process is carried out for a further reduction of the data representation. Hence, the transform coefficients undergo quantization. One way of quantization is to divide parameter values by a number, which results in a smaller number that may be represented by fewer bits. This quantization process results in the reconstructed video sequence being somewhat different from the uncompressed sequence. This phenomenon is referred to as “lossy coding.” The outcome from the quantization part is referred to as quantized transform coefficients.

Entropy coding is a special form of lossless data compression. Entropy coding involves arranging the image components in a “zigzag” order employing a run-length encoding (RLE) algorithm that groups similar frequencies together, inserting length coding zeros, and then using Huffman coding on what is left.

In H.264 encoding, the DCT coefficients for a block are reordered in order to group together non-zero coefficients in an array, enabling efficient representation of the remaining zero-valued coefficients. FIG. 1 shows the zigzag reordering path 100 (i.e., scan order). The pattern of the order of the zigzag scan 100 is configured according to the probability of non-zero coefficients in each positions. Due to the characteristics of the preceding DCT, the probability of non-zero coefficients in a block decreases in the downward right diagonal direction of a DCT block. When reordering the coefficients in a zigzag pattern 100, as illustrated in FIG. 1, the non-zero coefficients generally tend to concentrate in the first positions of the array.

The output of the reordering process includes a one-dimensional array that contains one or more clusters of non-zero coefficients near the start, followed by strings of zero coefficients. Due to the large number of zero values, the array is further is represented as a series of (run, level) pairs, where “run” indicates the number of zeros preceding a non-zero coefficient, and “level” indicates the magnitude of the non-zero coefficient. As an example, the input array 16, 0, 0, −3, 5, 6, 0, 0, 0, 0, −7, will have the following corresponding run-level values: (0,16), (2,−3), (0,5), (0,6), (4,−7). When transforming the zigzag array to run-level values, it is computationally expensive to loop over all coefficients and check whether they are non-zero.

### SUMMARY

The present disclosure describes a method, system, and computer readable medium. By way of example, there is a method for calculating run and level representations of quantized transform coefficients representing pixel values included in a block of a video picture, the method including packing, at a video processing apparatus, each quantized transform coefficients in a value interval [Max, Min] by setting all quantized transform coefficients greater than Max equal to Max, and all quantized transform coefficients less than Min equal to Min; reordering, at the video processing apparatus, the quantized transform coefficients according to a predefined order depending on respective positions in the block resulting in an array C of reordered quantized transform coefficients; masking, at the video processing apparatus, C by generating an array M containing ones in positions corresponding to positions of C having non-zero values, and zeros in positions corresponding to positions of C having zero values; generating, at the video processing apparatus, for each position containing a one in M, a run and a level representation by setting the level value equal to an occurring value in a corresponding position of C; and setting, at the video processing apparatus, for each position containing a one in M, the run value equal to the number of proceeding positions relative to a current position in M since a previous occurrence of one in M.

As should be apparent, a number of advantageous features and benefits are available by way of the disclosed embodiments and extensions thereof. It is to be understood that any embodiment can be constructed to include one or more features or benefits of embodiments disclosed herein, but not others. Accordingly, it is to be understood that the embodiments discussed herein are provided as examples and are not to be construed as limiting, particularly since embodiments can be formed to practice the invention that do not include each of the features of the disclosed examples.

### BRIEF DESCRIPTION OF THE DRAWINGS

The disclosure will be better understood from reading the description which follows and from examining the accompanying figures. These are provided solely as non-limiting examples of embodiments. In the drawings:

FIG. 1 illustrates a conventional zigzag pattern used to order the transform coefficients before entropy coding;

FIG. 2 is a flow chart illustrating a conventional implementation of run-level coding;

FIG. 3 is a flow chart illustrating an embodiment of run-level coding of the present disclosure;

FIG. 4 is an example of a bit mask of transform coefficients during different steps of the present disclosure; and

FIG. 5 illustrates a computer system upon which an embodiment of the present disclosure may be implemented.

### DETAILED DESCRIPTION

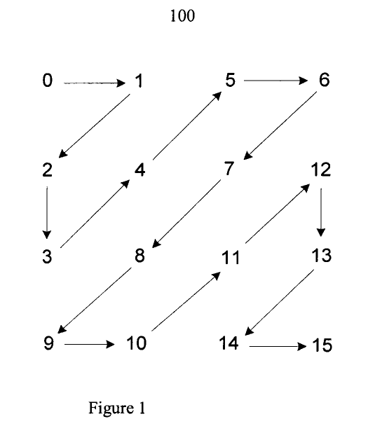

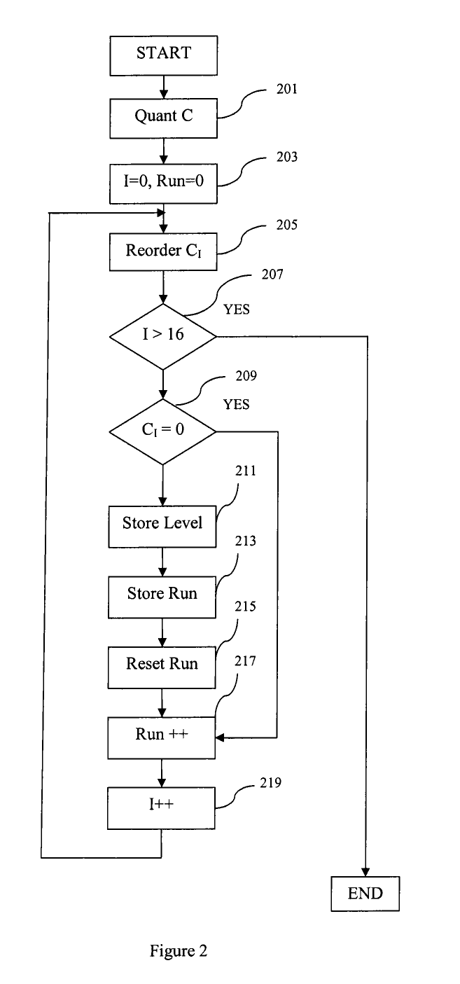

FIG. 2 is a flow chart illustrating how the run-level code, according to Moving Picture Experts Group (MPEG-4) and H.264, is calculated in a conventional implementation. After quantizing the transform coefficients (Quant C) 201 in a block, the Run variable and the position index (I) are set to zero 203. Then, the quantized coefficients are reordered 205 to a one-dimensional array according to the aforementioned zigzag pattern 100 shown in FIG. 1. The process then enters into a loop for parsing the array to determine the run-level values. First, it is checked whether the number of positions in the array is exceeded (i.e., I>16) 207. If not, it is then checked whether current position in the array contains a zero 209. If so, both the Run variable and the position index (I) are incremented, at steps 217 and 219, and the process proceeds to the start of the loop. If the current position contains a non-zero value, the current Run variable and the value of the current position are stored as the Run-Level value, at steps 211 and 213. The Run variable is then reset 215, before both the Run variable and the position index (I) are incremented, at steps 217 and 219, and the process proceeds to the start of the loop. The process ends whenever the position index (I) exceeds the maximum size of the array, which, in the example illustrated in FIG. 2, is 16.

As can be seen from the conventional implementation illustrated in FIG. 2, the process always has to run through the run-level encoding loop as many times as there are positions in the array (i.e., 16 times in the example of FIG. 2). This becomes very inefficient as most coefficients in C are zero, and it is computationally expensive to loop over all coefficients and check whether they are non-zero.

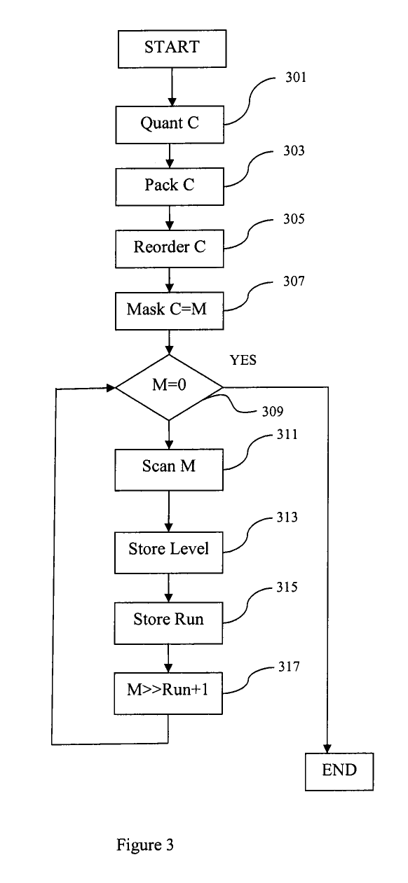

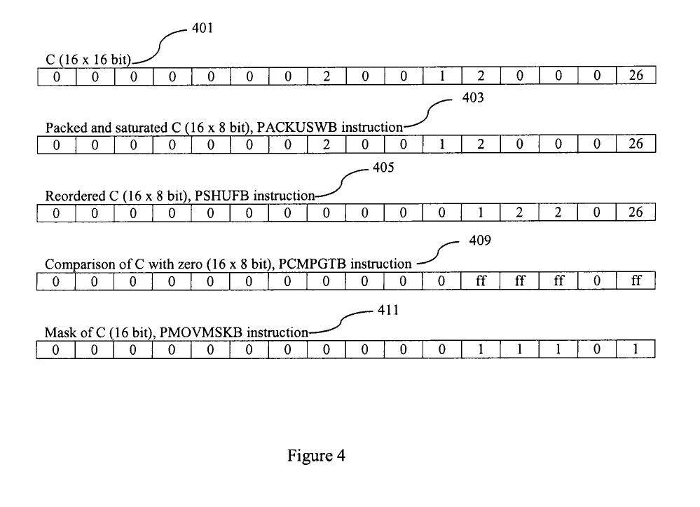

FIG. 3 is a flow chart illustrating an embodiment according to the present disclosure. According to this embodiment, bit-masks and bit-scan instructions, which make it possible to efficiently jump over all the zero valued coefficients, are used. First, the transform coefficients in the block are quantized at step 301. In the example of FIG. 3, there are sixteen (16) coefficients that are stored in the vector C, as shown in 401 of FIG. 4.

The process then proceeds to step 303 where all the quantized coefficients are packed. In this example, the packing 303 is done by the C++ instruction PACKUSWB, which transforms sixteen (16) signed words to unsigned integers and saturates, as shown in 403 of FIG. 4. In other words, if a coefficient is larger or smaller than the range of an unsigned byte, the coefficient is set to respectively Max or Min values of the range, which are 255 and 0 in this example. Accordingly, the size of the memory used to store each coefficient is reduced from two (2) bytes, which is usually the amount of memory needed to store each coefficient, to one (1) byte.

This is an approximation and may lead to different results when very low Quantization Parameters are used. However, extensive monitoring of this approximation for a wide variety of video-conferencing scenarios has shown that this approximation does not degrade video quality in any sense visible to the human eye.

The packing step 303 enables the reordering 305 of the coefficients to be carried out in one function, without having to parse a loop sixteen (16) times. This may be achieved by using the C++ function PSHUFB. This function efficiently shuffles precisely sixteen (16) bytes in any order. An example of the reordering of C using the PSHUFB instruction is shown in 405 of FIG. 4. In the example of FIG. 3, the input is the sixteen (16) coefficients and the zigzag order 100 illustrated in FIG. 1.

The next step is to mask 307 the quantized, packed, and reordered coefficients. Masking is accomplished by applying the C++ functions PCMPGTB and PMOVMSKB. The PCMPGTB function fills a whole byte of ones (1's) in the position of non-zero values, and leaves the zeros (0's) unchanged in the position of zeros, shown in 409 of FIG. 4. Note that a byte is equal to 8 bits, thus eight (8) ones (1's), in binary, is the maximum capacity of one byte. In 409 of FIG. 4, the hexadecimal “ff” represents eight (8) ones (1's) in binary (i.e., an entire byte, as noted above). The PMOVMSKB function creates a 16-bit mask (i.e., Mask of C) from the most significant bits of sixteen (16) bytes, as shown in 411 of FIG. 4. The result of these two functions, when applied on the array of quantized, packed, and reordered coefficients (C), is a 16-bit array (M) where the ones (1's) indicate the corresponding positions of the non-zero values of C.

Having derived M from C, the step of calculating the run-level values becomes less computationally demanding and requires no loops for zero-values. As noted above, in the mask M, one bit is set for each non-zero value of C. Thus, when the 16-bit array (M) is zero, at step 309, all coefficients are zero and the run-level encoding is completed for that array.

If array M is nonzero, the C++ function BSF can be used to calculate the index of the first non-zero value of C, at step 311. BSF, or Bit Scan Forward, scans for the first bit that equals one (1) and stores the index of the first set bit into a register. BSF returns the bit index of the least significant bit of an integer (i.e., in the case of M, the first position of a one (1) starting from the right-hand side).

Hence, the index returned by BSF at step 311, when applied on M, is equal to the “run” and is used directly as look-up in the C array to determine the “level.” This is possible since C is already shuffled using the PSHUFB instruction.

The Run-value, as indicated by the BSF function, is then stored, at step 315, and after looking up the value localized at that position in the C array, is stored as the level value, at step 313.

At step 317, M is finally shifted to the right “Run+1” times to clear the index bit from M and prepare M for the next iteration in the loop. Accordingly, the content of M corresponding to run-level values already calculated is removed from M, and the loop can be applied in the same way to calculate the remaining run-level values (i.e., by scanning M again, at step 311, using the BSF function, which looks for the next non-zero value of M).

Since all the zeros (0's) are being jumped over by effectively using the BSF instruction, only non-zero coefficient runs are required to calculate all “level” and “run” values. The number of loops to be parsed in implementing the entropy coding may therefore be reduced, since the probability of occurrence of many zeros (0's) in a block of quantized coefficients is high.

The present disclosure avoids an indirect table look-up (i.e., pointer chasing) to determine the “level,” and uses a single efficient BSF instruction to calculate the “run.”

Further, the present disclosure provides run-level encoding with non-zero coefficient runs. For example, if five (5) values in C are non-zero only five (5) runs through the run-level encoding loop is needed. Thus, the checking of zero values of C is avoided, which otherwise may have lead to computationally costly branch mispredictions.

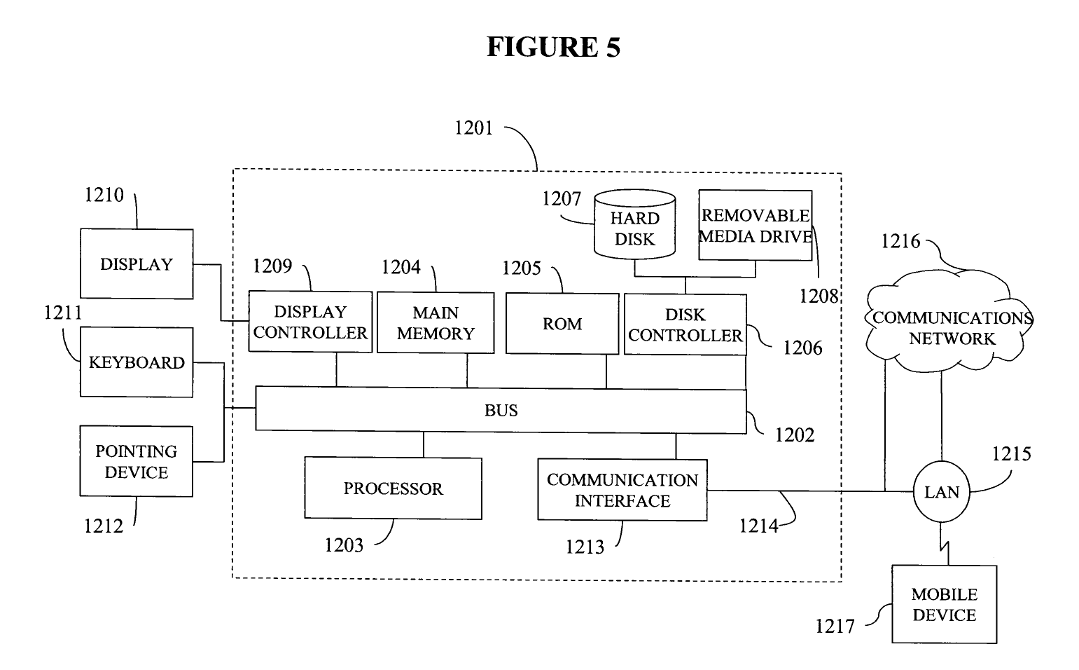

FIG. 5 illustrates a video processing apparatus 1201 upon which the method for calculating run and level representations, according to the present disclosure, may be implemented. The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a touch panel display or a liquid crystal display (LCD), for displaying information to a computer user. The GUI 308, for example, may be displayed on the display 1210. The computer system includes input devices, such as a keyboard 1211 and a pointing device 1212, for interacting with a computer user and providing information to the processor 1203. The pointing device 1212, for example, may be a mouse, a trackball, a finger for a touch screen sensor, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the present disclosure in response to the processor 1203 executing one or more sequences of one or more instructions contained in a memory, such as the main memory 1204. Such instructions may be read into the main memory 1204 from another computer readable medium, such as a hard disk 1207 or a removable media drive 1208.

One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the present disclosure and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes. Other embodiments may include the use of a carrier wave (described below), or any other medium from which a computer can read. Other embodiments may include instructions according to the teachings of the present disclosure in a signal or carrier wave.

Stored on any one or on a combination of computer readable media, the present disclosure includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present disclosure for performing all or a portion (if processing is distributed) of the processing performed in implementing the invention.

The computer code devices of the present embodiments may be any interpretable or executable code mechanism, including but not limited to scripts, interpretable programs, dynamic link libraries (DLLs), Java classes, and complete executable programs. Moreover, parts of the processing of the present embodiments may be distributed for better performance, reliability, and/or cost.

The term “computer readable medium” as used herein refers to any medium that participates in providing instructions to the processor 1203 for execution. A computer readable medium may take many forms, including but not limited to, non-volatile media or volatile media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present disclosure remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc.). The signals through the various networks and the signals on the network link 1214 and through the communication interface 1213, which carry the digital data to and from the computer system 1201 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

Further, it should be appreciated that the exemplary embodiments of the present disclosure are not limited to the exemplary embodiments shown and described above. While this invention has been described in conjunction with exemplary embodiments outlined above, various alternatives, modifications, variations and/or improvements, whether known or that are, or may be, presently unforeseen, may become apparent. Accordingly, the exemplary embodiments of the present disclosure, as set forth above are intended to be illustrative, not limiting. The various changes may be made without departing from the spirit and scope of the invention. Therefore, the disclosure is intended to embrace all now known or later-developed alternatives, modifications, variations and/or improvements.

1. A method for calculating run and level representations of quantized transform coefficients representing pixel values included in a block of a video picture, the method comprising:
packing, at a video processing apparatus, each quantized transform coefficients in a value interval [Max, Min] by setting all quantized transform coefficients greater than Max equal to Max, and all quantized transform coefficients less than Min equal to Min;
reordering, at the video processing apparatus, the quantized transform coefficients according to a predefined order depending on respective positions in the block resulting in an array C of reordered quantized transform coefficients;
masking, at the video processing apparatus, C by generating an array M containing ones in positions corresponding to positions of C having non-zero values, and zeros in positions corresponding to positions of C having zero values;
generating, at the video processing apparatus, for each position containing a one in M, a run and a level representation by setting the level value equal to an occurring value in a corresponding position of C; and
setting, at the video processing apparatus, for each position containing a one in M, the run value equal to the number of proceeding positions relative to a current position in M since a previous occurrence of one in M.

2. The method according to claim 1, wherein the masking further includes,
creating an array C′ from C where positions corresponding to positions of non-zero values in C are filled with ones, and positions corresponding to positions of zero values in C are filled with zeros, and
creating M from C′ by extracting the most significant bit from values in respective position of C′ and inserting the bits in corresponding positions in M.

3. The method according to claim 2, wherein the creating of the array C′ is executed by a C++ function PCMPGTB, and the creating of M from C′ is executed by a C++ function PMOVMSKB.

4. The method according to claim 1, wherein the generating of the run and level representation further includes determining positions containing non-zero values in C by corresponding positions containing ones in M.

5. The method according to claim 4, wherein the determining of positions containing non-zero values in C is executed by a C++ function BSF.

6. The method according to claim 1, wherein Max is 256 and Min is 0.

7. The method according to claim 1, wherein the predefined order follows a zigzag path of transform coefficient positions in the block starting in an upper left corner heading towards a lower right corner.

8. An apparatus for calculating run and level representations of quantized transform coefficients representing pixel values included in a block of a video picture, the apparatus comprising:
a video processor that,
packs each quantized transform coefficients in a value interval [Max, Min] by setting all quantized transform coefficients greater than Max equal to Max, and all quantized transform coefficients less than Min equal to Min;
reorders the quantized transform coefficients according to a predefined order depending on respective positions in the block resulting in an array C of reordered quantized transform coefficients;
masks C by generating an array M containing ones in positions corresponding to positions of C having non-zero values, and zeros in positions corresponding to positions of C having zero values;
generates, for each position containing a one in M, a run and a level representation by setting the level value equal to an occurring value in a corresponding position of C; and
sets, for each position containing a one in M, the run value equal to the number of proceeding positions relative to a current position in M since a previous occurrence of one in M.

9. The apparatus according to claim 8, wherein when the video processor masks C, the video processor further,
creates an array C′ from C where positions corresponding to positions of non-zero values in C are filled with ones, and positions corresponding to positions of zero values in C are filled with zeros, and
creates M from C′ by extracting the most significant bit from values in respective position of C′ and inserting the bits in corresponding positions in M.

10. The apparatus according to claim 9, wherein when the video processor creates the array C′, the video processor executes a C++ function PCMPGTB, and when the video processor creates M from C′, the video processor executes a C++ function PMOVMSKB.

11. The apparatus according to claim 8, wherein when the video processor generates the run and level representation, the video processor further determines positions containing non-zero values in C by corresponding positions containing ones in M.

12. The apparatus according to claim 11, wherein when the video processor determines the positions containing non-zero values in C, the video processor executes a C++ function BSF.

13. The apparatus according to claim 8, wherein Max is 256 and Min is 0.

14. The apparatus according to claim 8, wherein the predefined order follows a zigzag path of transform coefficient positions in the block starting in an upper left corner heading towards a lower right corner.

15. A computer readable storage medium encoded with computer executable instructions, wherein the instructions, when executed by a video processing apparatus, cause the video processing apparatus to perform a method for calculating run and level representations of quantized transform coefficients representing pixel values included in a block of a video picture, the method comprising:
packing, at the video processing apparatus, each quantized transform coefficients in a value interval [Max, Min] by setting all quantized transform coefficients greater than Max equal to Max, and all quantized transform coefficients less than Min equal to Min;
reordering, at the video processing apparatus, the quantized transform coefficients according to a predefined order depending on respective positions in the block resulting in an array C of reordered quantized transform coefficients;
masking, at the video processing apparatus, C by generating an array M containing ones in positions corresponding to positions of C having non-zero values, and zeros in positions corresponding to positions of C having zero values;
generating, at the video processing apparatus, for each position containing a one in M, a run and a level representation by setting the level value equal to an occurring value in a corresponding position of C; and
setting, at the video processing apparatus, for each position containing a one in M, the run value equal to the number of proceeding positions relative to a current position in M since a previous occurrence of one in M.

16. The computer readable medium according to claim 15, wherein the masking further includes,
creating an array C′ from C where positions corresponding to positions of non-zero values in C are filled with ones, and positions corresponding to positions of zero values in C are filled with zeros, and
creating M from C′ by extracting the most significant bit from values in respective position of C′ and inserting the bits in corresponding positions in M.

17. The computer readable medium according to claim 16, wherein the creating of the array C′ is executed by a C++ function PCMPGTB, and the creating of M from C′ is executed by a C++ function PMOVMSKB.

18. The computer readable medium according to claim 15, wherein the generating of the run and level representation further includes determining positions containing non-zero values in C by corresponding positions containing ones in M.

19. The computer readable medium according to claim 15, wherein the determining of positions containing non-zero values in C is executed by a C++ function BSF.

20. The computer readable medium according to claim 15, wherein the predefined order follows a zigzag path of transform coefficient positions in the block starting in an upper left corner heading towards a lower right corner.
